(19) United States
(12) Patent Application Publication
(10) Pub. No.: US 2012/0232907 A1
(43) Pub. Date: Sep. 13, 2012

(54) System and Method for Delivering a Human Interactive Proof to the Visually Impaired by Means of Semantic Association of Objects

(76) Inventor: Christopher Liam Ivey, Ottawa (CA)

(21) Appl. No.: 13/044,360

(22) Filed: Mar. 9, 2011

(51) Int. Cl. G10L 13/00

(52) U.S. Cl. 704/273; 704/E13.001

(57) ABSTRACT

A system and method for delivering a Human Interactive Proof, or reverse Turing test to the visually impaired; said test comprising a method for restricting access to a computer system, resource, or network to live persons, and for preventing the execution of automated scripts via an interface intended for human interaction.

When queried for access to a protected resource, the system will respond with a challenge requiring unknown petitioners to solve an auditory puzzle before proceeding, said puzzle consisting of an audio waveform representative of the names or descriptions of a collection of apparently random objects.

The subject of the test must either recognize a semantic or symbolic association between two or more objects, or isolate an object that does not belong with the others, indicating their selection by typing the name of the object with their keyboard.

### REFERENCES

US. Patent Documents

| | | |
|---|---|---|
| 7,603,706 | October 2009 | Donnely, et al. |
| 7,606,915 | October 2009 | Calinov, et al. |
| 7,197,646 | March 2007 | Fritz, et al. |
| 7,149,899 | December 2006 | Pinkas, et al. |
| 7,139,916 | November 2006 | Billingsley, et al. |
| 6,954,862 | October 2005 | Serpa, Michael Lawrence |
| 6,240,424 | May 2001 | Hirata, Kyoji |
| 6,195,698 | February 2001 | Lillibridge, et al. |
| 12/696,053 | January 2010 | Christopher Liam Ivey |

### CROSS-REFERENCE TO OTHER PATENTS

This application is a Continuation-in-Part of, and claims priority to co-pending U.S. patent application Ser. No. 12/66,053, entitled “System and Method for Restricting Access to a Computer System to Live Persons by Means of Semantic Association of Images”, which was filed on Jan. 29, 2010, and which is herein incorporated by reference in its entirety.

### OTHER REFERENCES

1. Alan Turing, “Computing Machinery and Intelligence”, Mind (journal), 1950
2. Gregg Keizer, “Spammers' bot cracks Microsoft's CAPTCHA: Bot beats Windows Live Mail's registration test 30% to 35% of the time, says Websense”, Computerworld’”, February, 2008
3. Kyle VanHemert, “Advertising Captchas: Annoying Squared”, Gizmodo.com (online journal), September, 2010

### BACKGROUND OF THE INVENTION

The Problem

In his 1950 paper Computing Machinery and Intelligence¹, Alan Turing proposed his now famous test, in which a computer is said to be thinking if it can win a game in which a human judge attempts to distinguish between human and mechanical interlocutors.

However, over time it has become apparent that the inverse of that question has become more pressing: can a machine distinguish between human operators and other machines?

The reason for this is that commercial and social networking applications on the Internet are becoming increasingly plagued by unscrupulous marketers, and opportunists who use software to exploit interfaces intended for human users to flood websites, online forums and mail servers with unsolicited marketing—or worse yet, by criminals who exploit weaknesses in human interfaces to capture data for fraudulent purposes.

If a person is limited to interacting with a computer system by physically typing requests, the amount of data he can gather, and the amount of damage he can do is limited; but with the aid of malicious software, a single operator can flood a network with millions of spam messages, or make thousands of requests for data in just a few seconds.

It turns out that limiting human interfaces to human operators is a critical task, and a substantial amount of intellectual property has been devoted to this problem—especially in the past few years. The so-called “Reverse Turing Test” has become an important problem for software developers.

The problem is that none of the current technologies are completely effective. Automated programs created by spammers have proven to be as much as 35%² effective when deployed against commercial solutions like Microsoft's Live Mail and Google's Gmail service.

Most of the research so far has focused on the mechanical aspects of how human beings recognize images, and a lot of effort has gone into discovering ways to distort images so they are still human-recognizable, but are computationally expensive for machines to resolve.

The standard “Captcha”, or reverse Turing test uses a sequence of glyphs, (letters and numbers), that have been run together, or warped, or have lines drawn through them, or have otherwise been altered to make them difficult to isolate and classify.

For their part, spam marketers and other agents who want to break live person verification systems have been developing technology to break down the job of recognition into three steps: preprocessing and noise reduction; segmentation; and classification.

The problem with using simple glyphs like letters and numbers is that there aren't many of them that are in regular use by humans, (for practical purposes they're pretty much limited to the characters on a typical computer keyboard), and in order to be recognizable at all, they must obey basic rules with regard to silhouette. This means that if you distort the glyphs enough that they can't readily be classified with software, human readers likely won't be able to recognize them either.

Some developers have attempted to use shape or image recognition instead of glyphs as a reverse Turing test. For example, Microsoft's Asirra uses a database of pet images provided in partnership by Petfinder.com. Users are asked to separate cats from dogs in a list of photographs.

Here again, there's a problem. Spam marketers who wish to break image recognition tests have demonstrated that they can simply enlist human agents to collect and classify images from very large databases in a surprisingly short time. From that point on, it's simply a matter of digital “grunt work” to compare known images with those presented by a reverse Turning test. This is the kind of work that computers excel at.

Systems that use shape recognition as a reverse Turing test can be broken by a similar process and with even less effort, since you generally have to use a restricted range of simple silhouettes that won't confuse human users.

The fact is, computers have become so powerful and inexpensive that you can't rely on computational expense to protect computer networks from machine agents.

An Epistemological Approach

Curiously, most of the research I have read in this field is related to the mechanical process of how people see—how they isolate shapes from the background, and segment them into individual objects.

There seems to be a surprising lack of epistemological curiosity as to how it is that humans know what a thing is once they have perceived it. Machines can be trained to perceive things. For many academics jury is still out as to whether they can ever know things.

For my part, I don't believe they can. A computer is a remarkably simple machine that inhabits an entirely pragmatic and platonic universe: it can only recognize a thing by comparing it against the same thing. Otherwise, it can only compare similarities.

You can use a machine to compare apples to oranges, but to a computer, an apple can only be said to be an apple if it's the same apple you started with. Only human beings can encompass the idea of an apple.

In other words, human beings recognize objects as ideas. More importantly, they can just as quickly grasp a whole host of associations between ideas that are unpredictable, in some cases illogical—and always human.

It is these semantic associations that tell us, for example, that a shabby, comfortable chair belongs at a cheerful fireside, while a sleek plastic office chair does not.

I believe that in the long run, the only truly successful test for a human presence on a computer system requires that we exploit the semantic and symbolic associations that a human being can make—and will always try to make in any random collection of objects; and that a machine by definition can not.

To be successful, a reverse Turing test can only be composed or created by a human agent, although it can be administered by a machine.

The Proposed Test

In the original invention, I proposed a system and method for constructing a Human Interactive Proof, or reverse Turing test, by using images of objects. While this remains the simplest and most effective way of delivering a test to sighted persons, it is not workable for the visually impaired.

It turns out that the same underlying technology can be used to the benefit of the visually impaired by means of a few simple additions to the system.

What I propose in this invention is a system where a computer will assemble an auditory test out of associations created in advance by human operators. Essentially, there are two variations on the test: one is to find two or more objects in an apparently random collection that should go together. In the other variation, the subject has to find the object that doesn't belong—much like the old association game on the PBS television program, Sesame Street.

Because of the arbitrary fashion in which humans associate things, a relatively small database of objects can result in thousands of matches—often incorporating the same objects in different ways. For example, consider the following objects: dog, boy, steak, frying pan, fish, baseball bat, baseball, table, and chair.

The dog is compatible with the boy, the ball, the steak, and possibly the fish, but not the table or the frying pan. The steak and the fish are compatible with the frying pan, and possibly the table, but the table is more compatible with the chair.

Humans will naturally link objects that have the strongest functional association, so if they are asked to match the table with any of the other objects, they will almost always choose the chair. After all, you almost always sit on a chair when at a table—but the steak and the fish or confusing. A human being will cast about looking for a plate and possibly a knife and fork.

This is because humans instinctively organize objects in collections. A machine has no way of making the arbitrary associations that allow humans to collect objects that often have no immediate and discernible qualities in common.

Subtle differences in objects can affect their association as well. It makes sense to associate a boy and his dog, but it makes more sense to the person taking the test if the dog is a beagle than it does if the dog is a pit bull terrier.

How it Would Work

We can create a test that can be assembled and administered by a machine, but only if the essential semantic associations that it is based on are first created by human operators. The test would be assembled from photo objects, each of which would be associated with metadata recorded by human operators.

That's right: photo objects. The original metadata both for sighted individuals and for the visually impaired would be created from a set of images.

Semantically, we tend to classify objects in three ways: qualitatively, or in terms of its own properties, (is it soft, or hard, or shiny?); functionally, or in terms of what it does; and in terms of its emotive context, (how does it make you feel?).

Each image would be represented in a database with three sets of metadata which would consist of tags describing the emotive, qualitative, and functional properties of the object with keywords. And—this is the important part—the metadata would have to be created by human operators who would describe the objects in the images in human terms.

To further help in creating associations, each noun used to describe a photo object would be linked to other nouns using a language-like syntax of verb associations to contain objects in sets, (noun HAS noun), supersets (noun IS noun), functional associations (noun CAN verb), and direct object to object associations (noun DOES noun).

To give a practical example, sample associations for the word “candle” might be: candle HAS wick, candle IS light source, candle CAN light, candle DOES candlestick.

The test could then be assembled by an artificial intelligence methodology that simply weighted sets of images based on the correspondence of metadata in each of the three categories, or more directly by exploiting functional noun to noun links in the metadata.

The test would be effectively tunable in terms of “fuzziness”, (based on the broadness of the correspondence of keywords over the categories), and difficulty, (by simply forcing users to differentiate between matches where there are points of correspondence between all of the images).

Supporting the Visually Impaired

Supporting the visually impaired turns out to be quite straightforward: The same metadata that is used to construct a visual test can be used to create an audio test. Every image object is associated with a localized, (translated) label which can be, depending on the embodiment of the invention, either translated directly to speech using text-to-speech technology, or simply associated with a spoken word audio clip.

The only other step would be altering the instruction string from “draw a line” or “circle the object” to “type the word”.

The audio test would be delivered as a sound recording that would invite the user to type in the best match for a keyword from a list of words, or to isolate and type in a word that doesn't belong in a list. Both of these embodiments are pretty much identical to the way tests would be constructed for sighted persons.

However, in tests for the hearing impaired, we would also have the option of creating tests where the solution string does not appear in the test itself. We could, for example, create an associative test where the user would be given a list of objects, and instructed to type in a word describing something that all of the objects have in common.

While this embodiment would require a more expensive evaluation algorithm, it would allow the creation of very secure tests, since even if you were able to extract all of the strings from the composite test audio waveform, the solution to the test would not appear, and would not be soluble without the use of an expert system to infer the semantic commonality between the objects listed.

Mechanical Improvements

Naturally, I have given thought to increasing the computational expense of collecting photo objects from the test and trying to re-create the relationships that are used in the test. In this case, I believe that the advantage lies with the agency administering the test rather than those who try to break it.

This is because they can only program computers to recognize the specific photo objects they encounter. They will need to employ human effort to associate the images and rebuild relationships, which is far more difficult in a fluid system than merely collecting images, especially since they can only solve for relationships amongst images they have already encountered, (which means the reverse-engineer effort is not easily distributable).

However, there is a very simple way to make it prohibitively difficult to collect and extract the photo objects used in any given collection: to do this, they would be overlaid on a photo background with a busy texture, using a soft edge and random variations in rotation and scaling. Once all of the images are assembled, the resulting composite would have a randomly modulated blend texture applied to it. The blend texture would be a regular shape repeated at random intervals and positions, and blended using a variety of additive, multiply or subtractive methods with a varying, low alpha.

Since photo objects are inherently more complex than glyphs, less distortion is required in order to render them useless for comparison and classification, yet is possible to subject them to more distortion and to completely change their orientation while they still remain recognizable. Because of this, the resulting image would still be highly recognizable to humans, but not easily compared to other instances of the same thing.

We would apply the same principals to protecting audio content from harvesting and interpretation.

Some measure of protection would be required, because if a spam marketer could correctly interpret when the instruction string begins and ends, they would then only have to correctly interpret six or seven strings in order to have as high as a sixteen percent chance of passing the test with a random solution.

To help prevent the use of audio harvesting and waveform matching, we would superimpose a randomly selected waveform of a sound that may or may not comprise a rhythmic or melodic structure.

The resulting test would still be easier to complete than most current audio based reverse Turing tests, because we would not be compelled to disguise the spoken words to the same extent. After all, the test does not consist of merely recognizing words, but rather of making a semantic association between a plurality of words.

The result would be a test that is more secure than the current norm, while remaining more accessible to users.

Reverse Turing Tests as a Platform for Brand Reinforcement

Hitherto, we have only discussed a basic embodiment of a reverse Turing test that exploits the semantic links humans intuit between images, as claimed by the inventor in U.S. application Ser. No. 12/696,053.

However, this unique approach of exploiting semantic links presents an ideal opportunity for fulfilling an additional purpose, which is the reinforcement of brand identity.

In an attempt to monetize and commercialize Human Interactive Proof or reverse Turing test applications, developers have explored a variety of dual purpose technologies, including using the subject of the test as a “mechanical Turk” or crowdsource worker to complete simple tasks—such as solving scanned text that OCR software can't interpret. Many have turned to one scheme or another for including advertising as part of a reverse Turing test.

Generating advertising revenue seems to be the simplest and most direct way to monetize a reverse Turing test, but there are couple of serious problems with this.

First of all, it's annoying to consumers to encounter what is essentially spam on an application designed to prevent spam. This is especially true given the fact that the majority of CAPTCHAs and similar tests are regarded as frustrating to use in the first place. The online technology publication Gizmodo described the product that results as “Annoying Squared”³.

Perception is important. If your goal is to reassure users that you are protecting your tools and application from spam and unwanted advertising, you can't risk undermining that perception by forcing your users to interact with advertising content over which you have no control.

The second problem with using reverse Turing tests as a platform for advertising is that advertisers generally don't want their images or advertising message to be distorted or obfuscated. This means advertising CAPTCHAs tend to be even less effective at preventing spam than most competing technologies.

However, there is a strong case to be made for capitalizing on a situation where users are required to concentrate on a puzzle or test. It's simply necessary to do this in a way that doesn't compromise the effectiveness of the application and in a way that is not perceived by users as exploitative.

What I propose with this invention is a method of using a reverse Turing test as a platform for brand reinforcement. A test that requires users to make semantic or functional links between images of objects is an ideal mechanism to do this—all you have to do is generate puzzles or tests that require you users to associate a branded object with a functionally linked object or situation.

For example, if the user is required to solve a puzzle where roasted coffee beans are meant to be matched with a cup of coffee, there's no reason why it couldn't be a cup of Starbuck's® coffee with the logo prominently displayed. This simple mechanism could be used to reinforce the brand functionality of virtually any household product: a white smile needs Crest® toothpaste; dirty socks would require the services of Tide® laundry detergent; Finish® dishwasher detergent results in sparkling clean glassware . . . .

All that is required to make the system work in this context is a mechanism for substituting a branded product for a generic image object, and a means of tracking and managing campaigns.

From the user's perspective, the system is completely transparent. Even though we are presenting them with a test that requires them to intuit a semantic association between a brand and its application, outcome, or context, the process of completing a branded test is no different than it would be for an unbranded test. It remains equally simple to complete, and the brand presentation takes place at much less liminal level than it would in the context of a traditional ad.

In most cases, the user would simply remain unaware that they have been presented with a brand proposition.

It's important to note that this is a system and method or brand reinforcement—not for advertising. In a traditional ad context, there is an overt message, a call to action, and additional information as to how to get the product and how much it costs. For example an ad for soda might read: “Belch's soda tastes great when you're thirsty! Only $3.99 a case. Buy it at your local grocer's”. In this case there's a clear message, (Belch's soda tastes great), a call to action, (buy it at your grocer's), and an appeal based on price, ($3.99 a case).

The invention I'm proposing here simply can't provide the same functionality without losing its perceived integrity as an anti-spam application. There can be no call to action, no overt message, and no straightforward metrics based on click-through.

What this invention does is quietly reinforce brand. In aggregate, this can be very effective. If, over the course of a two week campaign you require a million users to literally connect Dawn® dish detergent with sparkling clean dishes you will have made a very compelling argument for using Dawn® detergent instead of another brand. What you've done is train an aggregate population that Dawn® is the choice they should make if they want clean dishes.

### SUMMARY OF THE INVENTION

The invention is a system and method for delivering a Human Interactive Proof, (also called a reverse Turing test), to the visually impaired by means of semantic association of objects.

A Human Interactive Proof is a system and method for restricting access to a computer system, resource, or network to live persons, and for preventing the execution of automated scripts via an interface intended for human interaction. The invention will provide the functionality of a Human Interactive Proof, while simultaneously reinforcing consumer awareness of any brand or product introduced into the system.

When queried for access to a protected resource, computer system, or network, the system will respond with a challenge requiring unknown petitioners to solve an auditory puzzle before proceeding, said puzzle consisting of a spoken instruction to select a plurality of objects from a collection of apparently random objects and to type the corresponding words.

The subject of the test must either recognize a semantic or symbolic association between two or more objects, or isolate an object that does not belong with the others, and indicate their selection by typing the corresponding string with a computer keyboard or similar interface.

If the subject of the test succeeds in passing the test, they are granted access to the requested resource, computer system, or network. If not, they are invited to attempt the test again, up to a configurable maximum retests, after which time their request is simply ignored.

In the drawings, which form a part of this specification,

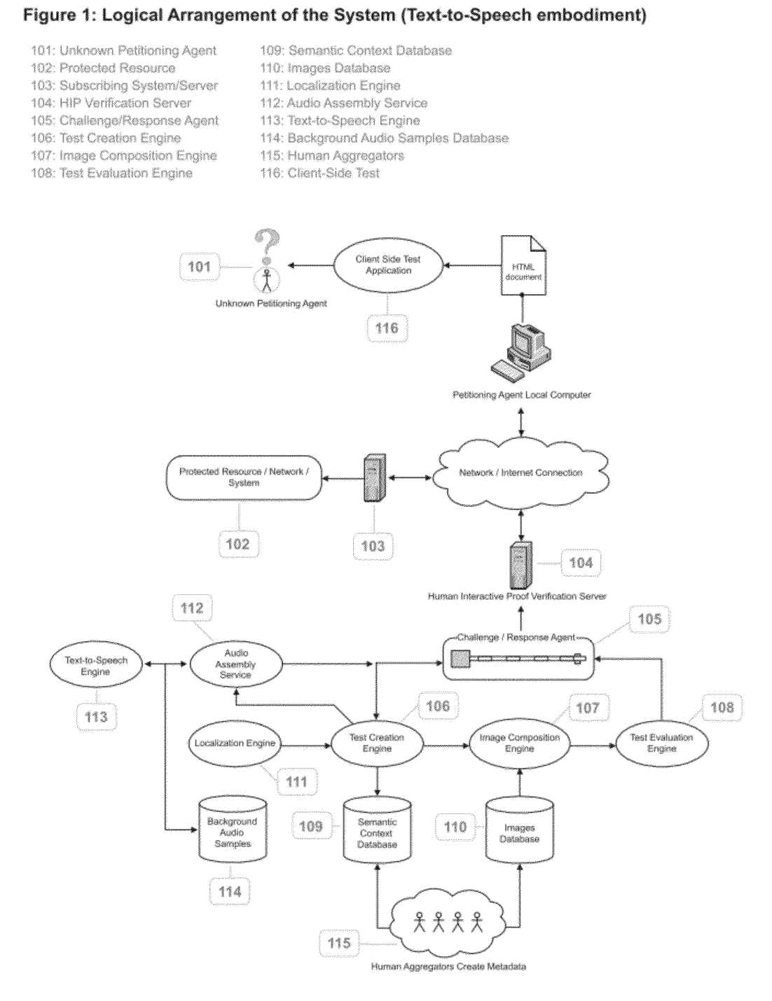

FIG. 1 is a logical diagram showing the preferred embodiment of a system for challenging and testing unknown petitioners for access to a protected resource with an auditory test; and

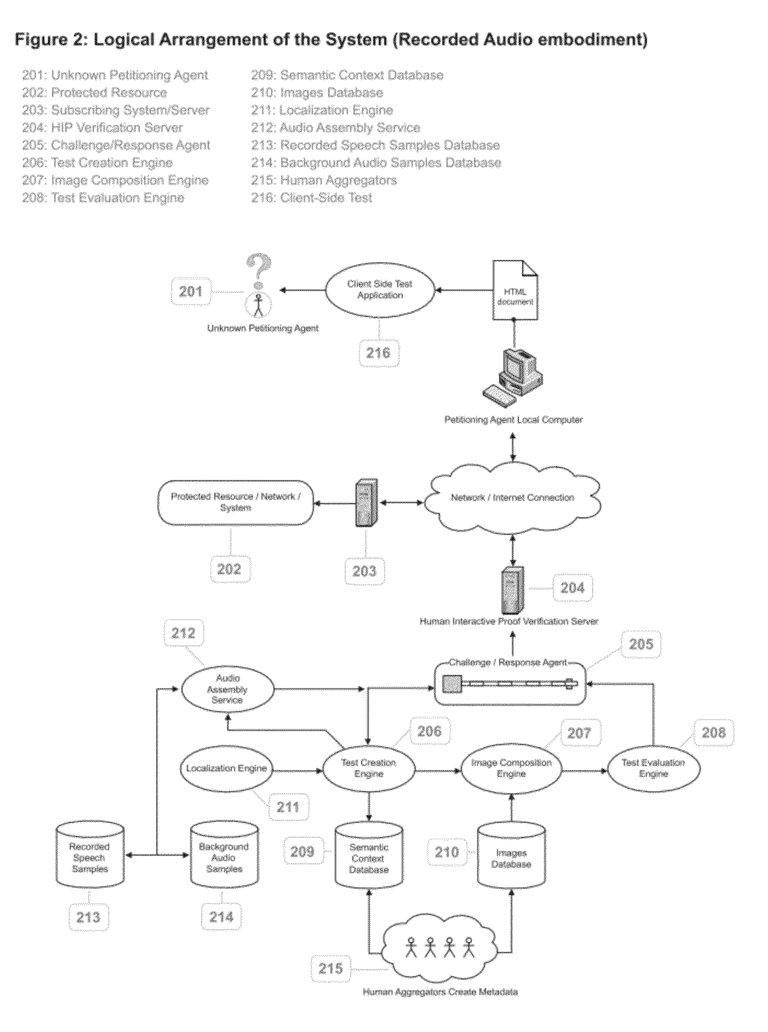

FIG. 2 is a logical diagram showing an alternate embodiment of the system; and

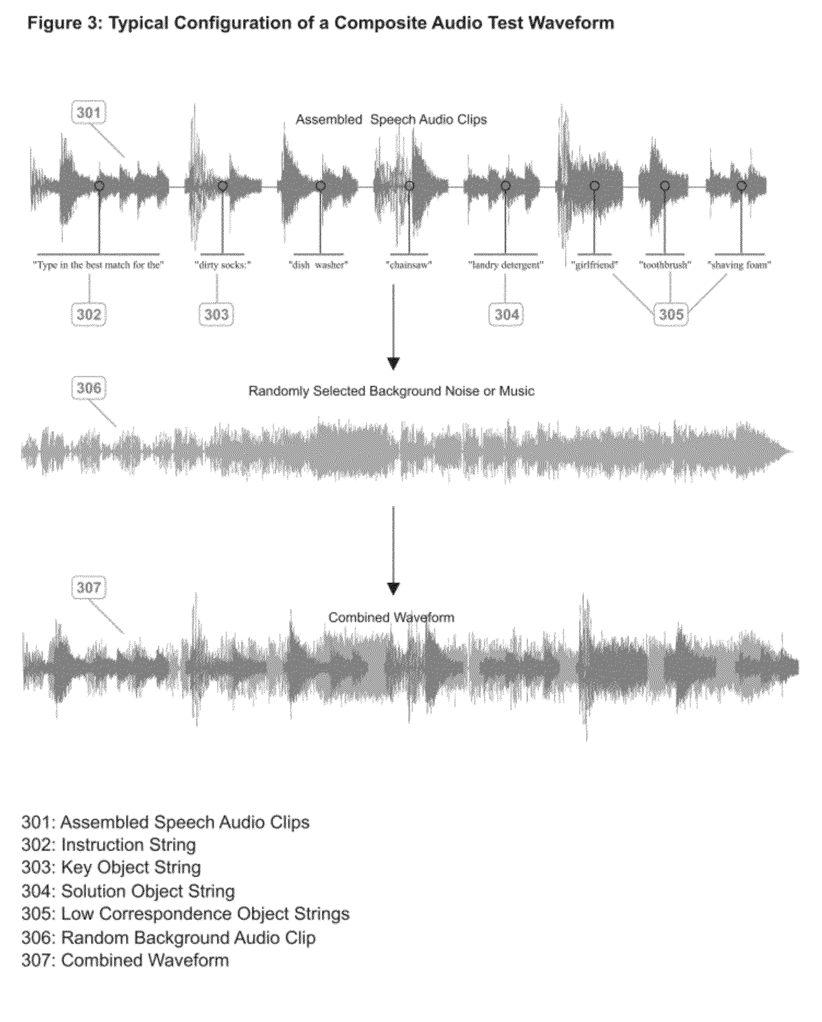

FIG. 3 shows the layout of a composite audio test as constructed by the system; and

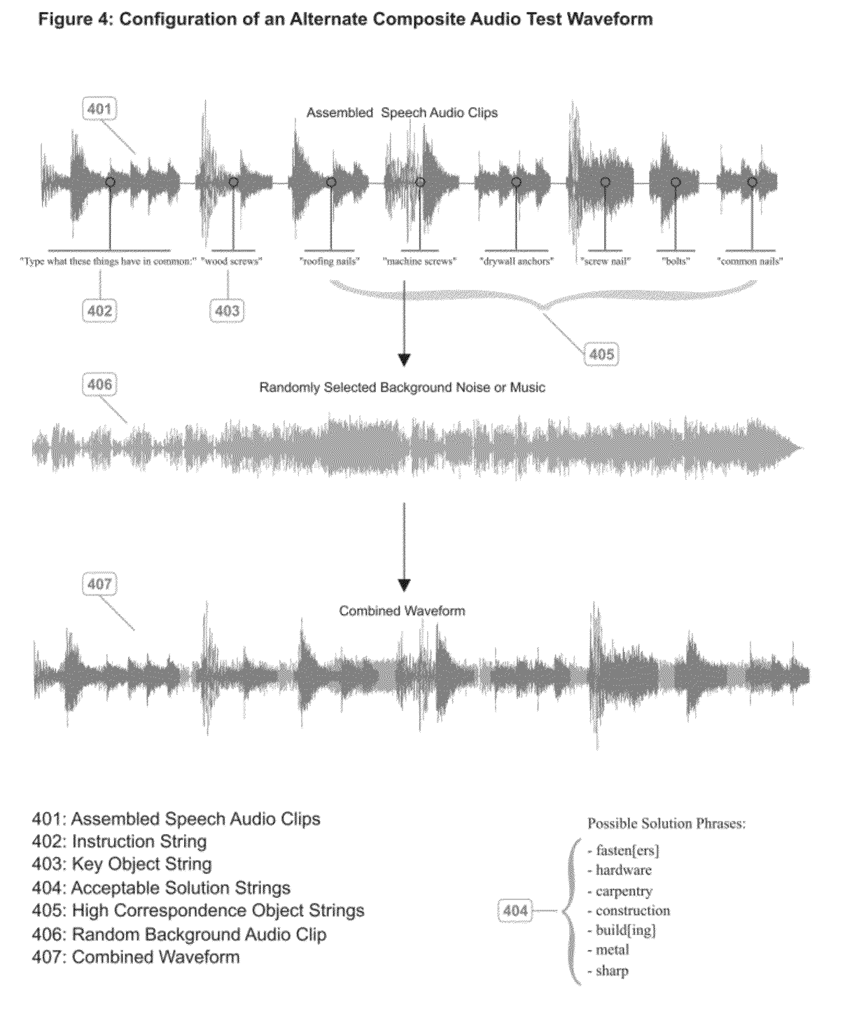

FIG. 4 shows the layout of a composite audio test in an alternate embodiment of the system; and

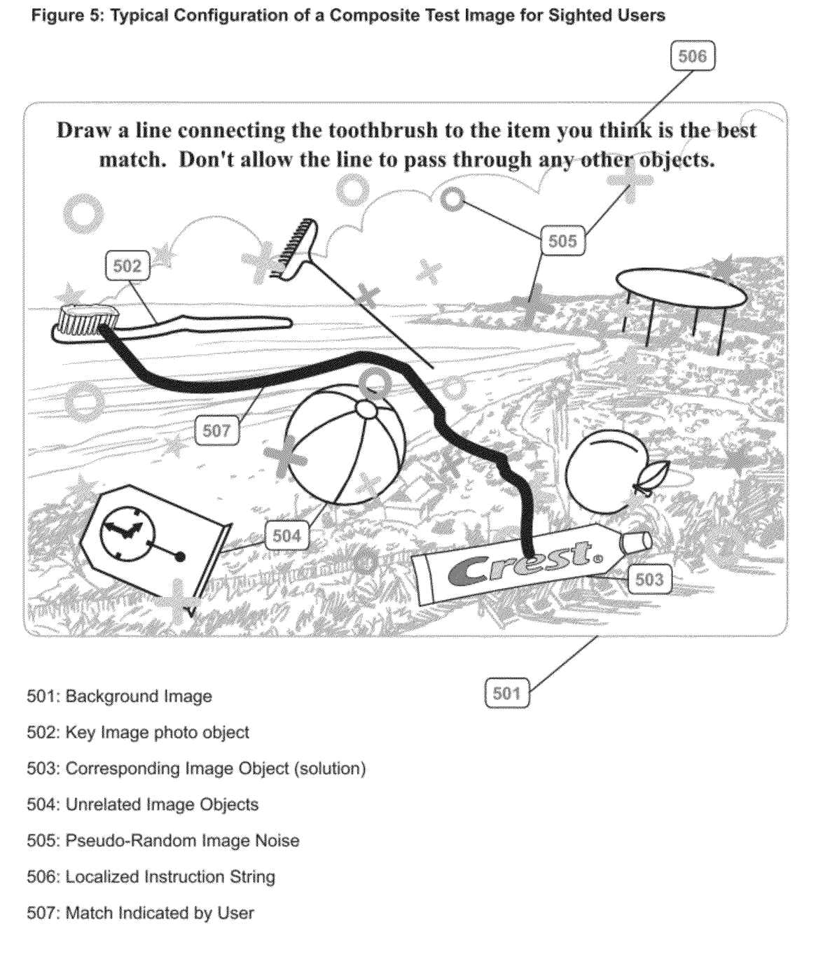

FIG. 5 shows the configuration of a composite test image for sighted users.

### DETAILED DESCRIPTION OF THE INVENTION

The invention is a system and method for delivering a Human Interactive Proof, (also called a reverse Turing test) to the visually impaired, for the purpose of restricting access to a computer system, resource, or network to live persons, and by extension for preventing the execution of automated scripts via an interface intended for human interaction.

In other words, it's a system to prevent spammers and malicious coders from exploiting web forms or information request pages that are intended for use by humans, and it does so in a way that makes it accessible to visually impaired persons.

As shown in FIG. 1, the system is resident on a plurality of servers connected to the Internet, and is available to organizations and entities which subscribe to the service [103] as a means of restricting access via the Internet to applications, services and resources that are resident on their own local computer systems, servers, and networks [102].

A Semantic Context Database [109] is created for an arbitrary collection of photo objects, (images in which a single object has been isolated against a transparent background), which are stored in an Images Database [110].

While these photo objects are intended to allow metadata to be generated by sighted operators, and to generate visual challenges as a Human Interactive Proof for sighted users, the same metadata is used to generate audio challenges as a Human Interactive Proof for the visually impaired.

Each entry in the Semantic Context Database must be created and aggregated by human operators [115]. Each image is identified with a unique ID, and associated with metadata that describes the image qualitatively, functionally, and emotively.

When a request is made by an Unknown Petitioning Agent [101] to access a protected resource [102], that resides on a computer system or server that subscribes to the service [103], a challenge request is sent to a Human Interactive Proof Verification Server [104].

The Human Interactive Proof Verification Server invokes the Challenge/Response Agent [105] which creates a session for the Petitioning Agent's computer, and then invokes the Test Creation Engine [106] to create a reverse Turing test for the session. In practice, of course, the Petitioning Agent [101] may or may not turn out to be a human user.

By default, the system will generate an image-based test for sighted persons; however, a user (the Unknown Petitioning Agent) can opt at any time to request an audio challenge for the visually impaired. The Unknown Petitioning Agent's preference is persisted by the Challenge/Response Agent as part of the session data.

The Test Creation Engine will then randomly determine the test type, which can either be associative or exclusive. An associative test requires the Unknown Petitioning Agent to identify an object in a collection, and then select another object in the collection that they feel semantically is the best match to the first object. An exclusive test requires the Unknown Petitioning Agent to identify the object they feel has the least in common with the other objects in a collection.

Test Creation Engine will first randomly select an image ID as the Key Image, (the first image which the Unknown Petitioning Agent is required to identify and match) for the test.

If the test is associative, the Test Creation Engine will first query the Semantic Context Database for the ID of an image which has associated metadata that closely corresponds to that of the Key Image in one or more metadata categories.

Each image object is associated with metadata entities, (or “tags”), that describe the object qualitatively, functionally, emotively, and by context. Each of these entities is in turn linked to other entities using a language-like syntax that organizes them into supersets; into subsets; by function; and by direct noun to noun interaction. Each object can inherit a whole host of associations by being linked to only a few metadata entities. Two objects are said to have a “high correspondence” if they share a lot of the same metadata entities, and a “low correspondence” if they don't.

The number of points of correspondence and the number of categories of correspondence required to link objects for the purpose of a test are configurable to allow a system administrator to modify the difficulty of the test.

At this point, the Test Creation Engine will have the unique IDs of two photo objects that a human being would be likely to associate as being related. The Test Creation Engine will then query the Semantic Context Database for a collection of image IDs which have associated metadata which has very few points of correspondence with the representative metadata for the Key image. The number of additional images and the number of points of correspondence are configurable to allow a system administrator to modify the difficulty of the test.

In an alternate embodiment of the invention, if the test is associative, and the Unknown Petitioning Agent has request a test for the hearing impaired, the Test Creation Engine will first query the Semantic Context Database for the IDs of a plurality of images that have associated metadata that closely correspond to that of the Key Image, as shown in FIG. 4. The Unknown Petitioning Agent would be required in this instance to indicate some quality held in common by all of the objects by typing it in with their keyboard.

If the test is exclusive, the Test Creation Engine will first query the Semantic Context Database for the unique IDs of a collection of multiple images which have associated metadata that closely corresponds to that of the Key Image in one or more metadata categories. The number of points of correspondence and the number of categories are configurable to allow a system administrator to modify the difficulty of the test.

At this point, the Test Creation Engine will have the unique IDs of a collection of photo objects that a human being would likely associate as being related. The Test Creation Engine will then query the Semantic Context Database for a single image which has very few points of correspondence with the representative metadata for the Key Image. The number of points of correspondence and the number of categories of correspondence required to link objects for the purpose of a test are configurable to allow a system administrator to modify the difficulty of the test.

The Test Creation Engine will then pass the ID of the Key Image, the IDs of the other images, and the test type, (associative or exclusive) to the Challenge/Response Agent, (which would have stored the language preferences of the user as part of the session data).

The Challenge/Response Agent would then invoke the Localization Engine [111] to create an instruction string for the Unknown Petitioning Agent. In the case of an associative test, the string would name the Key Image in the test and instruct the user to find the matching item, drawing a line joining the two items with their mouse or pointing device. In the case of an exclusive test it would instruct the user to find the object that doesn't belong and circle it by drawing a line with their mouse or pointing device.

If the Unknown Petitioning Agent has requested a test for the visually impaired, the Challenge/Response Agent would direct the Localization Engine to adapt the instruction string accordingly, instructing the Unknown Petitioning Agent to type in the name or description of the object they have selected, rather than indicating their selection by drawing a line with their pointing device or mouse as they would in a test for sighted persons. In the case of a test for the visually impaired, the Localization Engine would also look up the appropriate translation of the label strings for each of the photo objects selected for the test.

The localized label string for the object the Unknown Petitioning Agent is required to select, (either as the object that indicates the best match in an associative test, or as the object that doesn't belong with the others in an exclusive test), would be passed to the Test Evaluation Engine [108, 208] as the solution string for the test.

At this point, one of two things will happen:

If the Unknown Petitioning Agent has not requested a test for the visually impaired, The Challenge/Response Agent will then invoke the Image Composition Engine [107], and pass it the IDs of the images to be used in the test, together with the localized instruction string.

The Image Composition Engine will use these IDs to create a composite image designed to frustrate machine interpretation. The Image Composition Engine will first select a random background image from the Images Database. The background image will have been selected as a good candidate for the purpose, and will feature a strong pattern or random noise. The Image Composition Engine will then request all of the test images from the Images Database, and position them at random positions on top of the background image.

All of the parameters used by the Image Composition Engine are configurable in order to allow a system administrator to modify the difficulty of the test.

Last of all, the Image Composition Engine would render the text in the instruction string, and superimpose it on a space reserved either at the top or the bottom of the composite test image, as shown in FIG. 5 [506].

The Image Composition Engine will also create an image map corresponding to the composite test image that would track the position of the Key image and of the other test images. Once the composite test image and the image map are created, the Image Composition Engine will pass them to the Challenge/Response Agent.

However, if the Unknown Petitioning Agent has requested a test for the visually impaired, The Challenge/Response Agent will instead invoke the Audio Assembly Service [112], and pass it the localized instruction string, together with the localized label strings for each of the photo objects selected for the test.

In one possible embodiment of the invention, the Audio Assembly Service will pass each of the localized strings to a Text-to-Speech Engine [113]. The Text-to-Speech Engine will then generate a spoken word audio waveform for each string used in the test.

In an alternate embodiment of the invention as shown in FIG. 2, the Audio Assembly Service would instead look up a pre-recorded spoken word audio waveform in a Recorded Speech Sample Database [213] that corresponds to each of the localized strings created for the test.

As shown in FIG. 3, the Audio Assembly Service would then assemble the waveforms representing the instruction string [302], the key object string [303], the solution string [304], and the low-correspondence object strings [305] into a single, continuous audio waveform of the Assembled Speech Audio Clips [301].

Finally, the Audio Assembly Service would randomly select an audio waveform representative of music or background noise [306] from the Background Audio Samples Database [114, 214], and blend it with the Assembled Speech Audio Clips in order to create a single Combined Waveform [307]. The Audio Assembly Service would then pass the assembled audio test and the solution string to the Challenge/Response Agent.

Once the test is assembled, and the test image is created, the Challenge/Response agent will transmit the test image to the Subscribing System or Server [103], which in turn would deliver as part of a small Client-Side Test Application [116] on the Petitioning Agent's computer. The client-side application can be delivered as part of an HTML document, and can be implemented using any of a variety of common client-side application technologies, including AJAX, Java, Flash, or the Silverlight framework. The client/server communications for the challenge and the test do not require encryption.

In the event that the Unknown Petitioning Agent has selected a visual test for sighted persons, the Client-Side Test Application will display the test image and instruct the Petitioning Agent to use their pointing device complete the test. The rest of the instructions are embedded in the instruction string which is superimposed on the test image.

If the Unknown Petitioning Agent turns out to be a human user, they can simply use their mouse or pointing device to draw a line connecting the key image with its match [507], (if the test is associative), or to circle the one image that doesn't belong with the others, (if the test is exclusive). In either case, the Unknown Petitioning Agent would be required to draw a line with their mouse or pointing device. Merely requiring them to click on an object would not provide adequate security for the system.

The Client-Side Test Application will listen for a press event from the pointing device on the Petitioning Agent's computer. On press, (whether it is a button event on a mouse or a pressure event on a stylus or touch screen), the Client-Side Test Application will start recording the position of the pointing device every few milliseconds.

Once the Unknown Petitioning Agent or user releases the mouse button or otherwise generates a release event for the pointing device, the Client-Side Test Application will stop recording the position of the pointing device, and will transmit the path data it has collected to the Subscribing System or Server along with any other form or application data that has been collected.

In turn, the Subscribing System or Server will transmit the collected path data to the Challenge/Response Agent.

The Challenge/Response Agent will then pass the collected data and the image map for that test to the Test Evaluation Engine [108]. The Test Evaluation Engine will compare the pointing device position data to the image map.

In the case of an associative test, it will look for the start and end points of the line created by the pointing device, and check to see if they correspond to the position of the key image and the matching image. The Test Evaluation Engine will also check to see if the line created by the pointing device intersects any images that are unrelated to the key image. Failure on either of these two conditions would constitute a failure of the test.

In the case of an exclusive test, the Test Evaluation Engine will check to see if the line created by the pointing device encloses the area occupied by the image that doesn't belong with the others. It will also verify that the line created by the pointing device does not enclose any of the other photo objects in the test image. Failure on either of these two conditions would constitute a failure of the test.

If the Unknown Petitioning Agent has selected an audio test for the visually impaired, the Client-Side Test Application will play back the Combined Waveform provided by the Challenge/Response Agent, and start recording the keystrokes made by the Unknown Petitioning Agent as an input string.

When the Client-Side Test Application detects an <Enter> key press, it will transmit the recorded input string data to the Subscribing System or Server along with any other form or application data that has been collected.

In turn, the Subscribing System or Server will transmit the collected input string to the Challenge/Response Agent.

The Challenge/Response Agent will then pass the collected data and the solution string for that test to the Test Evaluation Engine [108]. The Test Evaluation Engine will compare the input string to the solution string.

In the event that the embodiment of the invention employed requires the Unknown Petitioning Agent to supply a word or phrase in common with all of the objects in the test, and does not provide the solution string as part of the Combined Waveform [407], the Test Evaluation Engine will query the Semantic Context Database to see if the input string is common to the associated metadata for all of the objects in the test.

If, for example, the input string is the word “metal” and all of the objects in the test have the quality “metal” associated with them in the Semantic Context Database, then the Test Evaluation Engine will determine a pass condition for the test.

Regardless of whether the completed test is a visual or audio test, once it has evaluated the test data, the Test Evaluation Engine will pass the test results back to the Challenge/Response Agent which in turn would provide a response to the Subscribing System or Server as either a pass or fail condition.

If the Petitioning Agent has passed the test, the Subscribing System or Server would allow the Petitioning Agent access to the requested resource. If not, it will return a message advising the Petitioning Agent of the failure.

In the case of a failure, the Petitioning Agent will be given the opportunity to take the test again, up to a maximum number of retests, which would be configurable by an administrator of the system.

1. A system for restricting access to a computer system, resource, or network to live persons, and for preventing the execution of automated scripts via an interface intended for human interaction by means of a reverse Turing test that exploits the semantic, symbolic, and contextual associations humans instinctively form between objects, and which is accessible to the visually impaired, the system comprising:
a) A computer system, resource, or network on which protected applications or data are resident, herein described as a Subscribing System or Server;
b) A Challenge/Response Agent, comprising a storage medium containing machine readable instructions which are executable by a computing platform and resident on a server; said Agent creating and managing a session each time a protected resource is requested by an unknown Petitioning Agent, and which allows or denies access to the requested resource, system, or network based on the outcome of a test designed to determine whether or not the Petitioning Agent is a human user;
c) A Test Creation Engine, comprising a storage medium containing machine readable instructions which are executable by a computing platform, said Engine creating a unique test for each verification session, based on a combination of configurable and random parameters;
d) An apparatus comprising non-volatile memory containing an Images Database containing a plurality of random images;
e) An apparatus comprising non-volatile memory containing a Semantic Context Database, containing a plurality of metadata associated with the unique ID of each image in the Images Database;
f) An apparatus comprising non-volatile memory containing a database in which is stored a plurality of random audio waveforms;
g) A Localization Engine, comprising a storage medium containing machine readable instructions which are executable by a computing platform, said Engine creating a localized instruction string to guide the Petitioning Agent in completing the test;
h) An Image Composition Engine, comprising a storage medium containing machine readable instructions which are executable by a computing platform, said Engine composing the images selected for a test into a single composite image, based on a combination of configurable and random parameters;
i) A Text-to-Speech Engine, comprising a storage medium containing machine readable instructions which are executable by a computing platform, said Engine converting labels associated with objects selected for a test into a digital data format representing spoken word audio wave forms;
j) An Audio Assembly Service, comprising a storage medium containing machine readable instructions which are executable by a computing platform, said Service composing audio wave forms generated by the Text-to-Speech engine into a digital data format representing a single blended audio wave form;
k) A Client-Side Test Application, comprising machine readable instructions which are executable by a computing platform which is executed on the local computer of the Petitioning Agent;
l) A Test Evaluation Engine, comprising a storage medium containing machine readable instructions which are executable by a computing platform, which examines the results returned by the Client-Side Test Application, and returns a pass or fail result to the Challenge/Response Agent.

2. A system according to claim 1, whereby the Challenge/Response Agent will respond to any request from an unknown Petitioning Agent for a protected resource, system or network by creating a test session and invoking the Test Creation Engine.

3. A system according to claim 1, whereby the Challenge/Response Agent will persist the unknown Petitioner's preference to receive a test for the visually impaired.

4. A system according to claim 1, whereby the Test Creation Engine will instantiate a new test which is randomly determined to be of either associative or exclusive logic, and request a single random key image ID from the Images Database.

5. A system according to claim 1, whereby if the test is associative the Test Creation Engine will query the Semantic Context Database for a collection consisting of the ID and name or description of a single image that is semantically associated with the key image and a plurality of image IDs that are not semantically associated; and if the test is exclusive, the Test Creation Engine will query the Semantic Context Database for a collection consisting of the IDs, and names or descriptions of a plurality of images that are not semantically associated with the key image.

6. A system according to claim 1, whereby the Test Creation Engine will query the Localization Engine for translated strings corresponding to the name or description of each of the key image and each of the image objects used in the test, together with a translated instruction string that will guide the user to type the name of an object associated with the key image object, (if the test is an associative test), or to type the name of an object that doesn't belong, (if the test is an exclusive test).

7. A system according to claim 6, whereby the Test Creation Engine will persist the translated string corresponding to the name or description of the key image object as the solution to the test.

8. A system according to claim 1, wherein the Test Creation Engine will pass the collection of translated strings to the Audio Assembly Service, which will in turn invoke the Text to Speech Engine to convert each string into a digital format representing an audio waveform.

9. A system according to claim 7, whereby the Audio Assembly will generate digital data representing a single blended audio waveform.

10. A system according to claim 1, whereby the Challenge/Response Agent will transmit the digital data representing the blended audio waveform to a Client-Side Test application, which can be embedded in an HTML document and is executed on the local computer of the Petitioning Agent.

11. A system according to claim 1, whereby the Client-Side Test application will instruct the Petitioning Agent to use the keyboard or input device on their local computer to complete the instructions embedded in the blended audio waveform.

12. A system according to claim 10, whereby the Client Side Test application will start recording the input from the keyboard, or other input on the Petitioning Agent's local computer, and will stop recording and transmit the collected position data back to the Challenge/Response agent when it receives an <Enter> key press or equivalent event.

13. A system according to claim 1, wherein the Challenge/Response Agent passes the test data to the Test Evaluation Engine, which will compare the input string data collected from the Petitioning Agent's computer, and compare it to the solution string for the test; returning a pass condition if the strings correspond and a failure condition if they do not.

14. A system according to claim 12, wherein the Test Evaluation can further examine the validity of the input string collected from the Petitioning Agent's computer by examining the metadata associated with each of the image objects in the Semantic Context Database, and return a pass condition if the input string occurs repeatedly in said metadata.

15. A system according to claim 1, whereby if the Test Evaluation Engine returns a pass result, the Challenge/Response Agent will instruct the Subscribing Server or System to allow the Petitioning Agent access to the requested computer system, resource, or network; and if it returns a failure result, the Challenge/Response Agent will transmit a failure notification to the Petitioning Agent.

16. A system according to claim 1, wherein if the Petitioning Agent fails to pass a test, the Challenge/Response Agent will allow the Petitioning Agent to request a new test, up to a maximum number of retests; after which, the Challenge/Response Agent will simply refuse all requests from the Petitioning Agent for the duration of cool-down time; the maximum number of retests and cool-down interval being configurable by an administrator of the system.

17. A method for recording and retrieving the semantic, and symbolic associations human beings make between images of objects, said method comprising the creation of metadata consisting of a plurality of words and phrases which describe each image qualitatively, (or in terms of appearance and other qualities); functionally, (or in terms of use and purpose and taxonomy); and emotively, (or in terms of emotional state affected in the viewer); said metadata being created and collected for each image in a collection by human operators.

18. The method of claim 16, wherein each image in a collection is examined by a human operator, and is recorded in a database, wherein it is associated with a plurality of collections of metadata, each containing a plurality of words and phrases, and which are separated by category as qualitative, functional, and emotive metadata.

19. The method of claim 16, wherein the nouns in said metadata collections are further associated with a plurality other nouns in a language-like syntax, wherein each noun can associate in the context of a subset, a superset, a functional interaction, or direct interaction.

20. A method for assembling the disparate audio waveforms used to generate the test into digital data representing a single, blended audio waveform intended to frustrate machine interpretation, and which can be played back in and audible form on the unknown Petitioning Agent's local computer, said method comprising the creation of a composite audio waveform created by superimposing:
a) A background audio component consisting of a randomly selected audio waveform representative of generated or recorded noise, said audio waveform being previously identified as suitable for the purpose by a human operator, and including an irregular pattern of repeating, contrasting elements, (such as those found in music or in traffic or conversational sounds);
b) The test audio content, consisting of audio waveforms representing the localized spoken word or phrase derived from the instruction string, or from naming or describing each of the image objects in the test, said waveforms having been generated by a text-to-speech engine or recorded source, and having been spliced end to end with short intervening silences.
